(19) United States
(12) Patent Application Publication
(10) Pub. No.: US 2005/0182179 A1
(43) Pub. Date: Aug. 18, 2005

(54) Aqueous pigment pastes containing mica pigments and the use thereof for producing aqueous, decorative-effect coatings

(76) Inventors: Gotz-Ekkehard Sapper, Rimpar (DE); Anne Hupp, Kist (DE)

Correspondence Address: BASF CORPORATION;ANNE GERRY SABOURIN, 26701 TELEGRAPH ROAD, SOUTHFIELD, MI, 48034-2442, US

(21) Appl. No.: 10/512,035

(22) PCT Filed: May 12, 2003
(86) PCT No.: PCT/EP03/04923

(30) Foreign Application Priority Data
May 16, 2002 (DE) 102 21 815.3
Jun. 29, 2002 (DE) 102 29 343.0

(51) Int. Cl. C08K 3/34

(52) U.S. Cl. 524/449

(57) ABSTRACT

A pigment paste free from binders and grinding resins, comprising based on its overall amount (A) from 15 to 25% by weight of at least one mica pigment,
(B) from 0.45 to 0.75% by weight of at least one nonassociative thickener comprising at least one methacrylate copolymer based on C₁-C₆ alkyl (meth)acrylate and (meth)acrylic acid, (C) from 0.1 to 0.4% by weight of at least one organic amine, (D) from 0.1 to 12% by weight of at least one nonionic surfactant, and (E) at least 50% by weight of water; its use for preparing aqueous coating materials, and processes for the preparation.

The present invention relates to novel aqueous pigment pastes comprising mica pigments but free from binders and grinding resins. The present invention further relates to the use of the novel aqueous pigment pastes comprising mica pigments but free from binders and grinding resins for producing aqueous effect coating materials. The present invention additionally relates to a novel process for producing aqueous effect coating materials.

Whereas the use of aluminum effect pigments in aqueous basecoat materials is well established, more recently the use of mica effect pigments has been on the increase, with the aim of realizing multicoat paint systems featuring particularly attractive color effects and optical effects.

On account of their comparatively high sensitivity to mechanical effects, mica pigments cause problems on incorporation into aqueous coating materials, especially aqueous basecoat materials.

The mica pigments are normally pasted or dispersed in organic solvents. A disadvantage here, as well as the use of organic solvents, is the rapid settling of the mica pigments, leading to inhomogeneities in the aqueous basecoat materials and in the multicoat color and/or effect paint systems.

Alternatively, the mica pigments can be dispersed in aqueous mixing varnishes whose physical composition corresponds substantially to that of the aqueous basecoat materials that are to be pigmented. Thus the aqueous mixing varnishes may comprise a polyurethane resin, a melamine resin, an amine, a phyllosilicate, organic solvents (cosolvents), and water. A disadvantage is that the pigment pastes in question have only a very limited shelf life of not more than a few days. After that time, settling occurs and inhomogeneities and coagulum are formed, reducing the quality of the multicoat color and/or effect paint systems. For industrial coating on the line at the automaker's plant as well, the inadequate shelf life is a major problem. Accordingly, the pigment pastes cannot be produced in sizeable amounts for holding in stock, although this would be desirable on economic grounds. The transportability of the pigments pastes also leaves much to be desired. As a result, the possibility of preparing the pigment pastes at one production site with optimum production conditions and transporting them to the customers is closed. Moreover, for the aftertinting of aqueous basecoat materials, the pigment pastes have to be prepared anew each time.

The article by Mike Venturini and Kurt Beale in Modern Paints & Coatings, February 2000, “Specialty pigments & additives, special treatment, dispersion and settling guidelines for pearlescent pigments in solvent- and water-based coatings” discloses a pigment paste composed of 45.9% by weight of water, 15% by weight of ethylene glycol butyl ether, 0.1% by weight of 2-amino-2-methyl-1-propanol, 2.5% by weight of a hydroxyl-containing polyacrylate grinding resin, 1.5% by weight of an alkali-swellable thickener, and 35% by weight of a mica pigment. Here again, the comparatively high level of organic solvents, and also the tendency to form inhomogeneities and coagulum, and the limited shelf life, are disadvantageous. Otherwise, the mica pigments can be stabilized sterically by means of surface charges, generated by ionic surfactants, or using nonionic surfactants. Steric stabilization is appropriate in particular for nonaqueous systems. These systems, however, have the disadvantages set out above.

It is an object of the present invention to provide a novel aqueous pigment paste comprising mica pigments which no longer has the disadvantages of the prior art but which instead can be prepared simply, without damage to the mica pigments, transportably, storably, and stably with a minimum level of organic solvents, additives, and polymeric binders. Preferably, the novel aqueous pigment paste comprising mica pigments ought to be storable for more than one year without settling and without the formation of inhomogeneities or coagulum.

It ought to be possible to prepare the novel aqueous pigment paste comprising mica pigments at a production site which offers optimum conditions and to transport it to the customers, especially the automakers. Accordingly, the stockholding complexity should be reduced significantly. Moreover, the novel aqueous pigment paste comprising mica pigments ought to be able to undergo shearing in the circuits of the coating plants readily without being damaged.

The novel aqueous pigment paste comprising mica pigments is intended to allow the preparation of storable, transportable aqueous coating materials, especially aqueous basecoat materials, which are stable in shade, stable in effect, and easy to apply, and which give outstanding multicoat color and/or effect paint systems of automobile quality (on this point, see also European patent EP 0 352 298 B 1, page 15 line 42 to page 17 line 40).

The invention accordingly provides the novel aqueous pigment paste comprising mica pigments but free from binders and grinding resins, said paste comprising based on its overall amount
(A) from 15 to 25% by weight of at least one mica pigment,
(B) from 0.45 to 0.75% by weight of at least one nonassociative thickener comprising at least one methacrylate copolymer based on C₁-C₆ alkyl (meth)acrylate and (meth)acrylic acid,
(C) from 0.1 to 0.4% by weight of at least one organic amine,
(D) from 0.1 to 12% by weight of at least one nonionic surfactant, and
(E) at least 50% by weight of water,
   and referred to below as “pigment paste of the invention”.

The invention also provides for the novel use of the pigment paste of the invention for producing aqueous effect, especially color and effect, coating materials, referred to below as “inventive use”.

The invention provides not least the novel process for preparing an aqueous effect or color and effect coating material by mixing at least one pigment paste with at least one aqueous mixing varnish comprising at least one water-soluble and/or -dispersible binder and homogenizing the resulting mixture, which involves mixing at least one pigment paste of the invention with the mixing varnish in an amount such that the resulting aqueous effect or color and effect coating material comprises based on its overall amount
from 2 to 6% by weight of at least one mica pigment (A),
from 0.1 to 2% by weight of at least one nonassociative thickener (B) comprising at least one methacrylate copolymer based on C₁-C₆ alkyl (meth)acrylate and (meth)acrylic acid, and
from 0.02 to 2.4% by weight of at least one nonionic surfactant (D).

The novel process for preparing an effect coating material is referred to below as “process of the invention”.

In the light of the prior art it was surprising and unforeseeable for the skilled worker that the object on which the present invention was based could be achieved by means of the pigment paste of the invention without the occurrence of the disadvantages of the prior art, depicted at the outset.

The pigment paste of the invention was simple to prepare without damage to the mica pigments. It was substantially or entirely free from organic solvents, binders, and grinding resins. Additionally, only comparatively small amounts of additives were needed. Despite this, the pigment paste of the invention was surprisingly stable, transportable, and storable. A particular surprise was that the pigment paste of the invention was storable for more than one year without settling and without the formation of inhomogeneities or coagulum.

The pigment paste of the invention could be prepared at a production site offering optimum conditions, and transported to the customers, especially the automakers. In this way it was possible to reduce significantly the complexity of stockholding for the customer. Moreover, the pigment paste of the invention could be sheared in the circuits of the coating plants readily without being damaged.

Surprisingly, the pigment paste of the invention gave storable, transportable aqueous coating materials, especially aqueous basecoat materials, which were stable in shade, stable in effect, and easy to apply.

The aqueous basecoat materials allowed the production of outstanding multicoat effect, or color and effect, paint systems of automobile quality. According to European patent EP 0 352 298 B 1, page 15 line 42 to page 17 line 14, this means that the multicoat paint systems in question had
(1) high gloss,
(2) high distinctiveness of image,
(3) high and uniform hiding power,
(4) uniform dry film thickness,
(5) high gasoline resistance,
(6) high solvent resistance,
(7) high acid resistance,
(8) high hardness,
(9) high abrasion resistance,
(10) high scratch resistance,
(11) high impact strength,
(12) high intercoat adhesion and adhesion to the substrate, and
(13) high weathering stability and UV resistance.

The pigment paste of the invention is free from binders and grinding resins. Regarding the term “binders”, refer to Römpp Lexikon Lacke und Druckfarben, Georg Thieme Verlag, Stuttgart, N.Y., 1998, “Binders”, pages 73 and 74. Grinding resins are used for dispersing pigments (cf. Römpp Lexikon Lacke und Druckfarben, Georg Thieme Verlag, Stuttgart, N.Y., 1998, “Dispersing”, page34) for the purpose of preparing pigment pastes or pigment preparations (cf. Römpp Lexikon Lacke und Druckfarben, Georg Thieme Verlag, Stuttgart, N.Y., 1998, “Pigment preparations”, page 452). They are binders whose capacity for dispersing pigments is particularly high.

In the context of the present invention, “free from binders and grinding resins” means that the pigment paste of the invention contains no binders and no grinding resins or only amounts thereof so small that they do not characterize, and in particular do not adversely affect, the performance properties of the pigment paste of the invention.

With preference, the pigment paste of the invention is also free from organic solvents. This means that the pigment paste of the invention contains only amounts of organic solvents so small that they do not characterize, and in particular do not adversely affect, the performance properties of the pigment paste of the invention. The amount of organic solvents, based on the pigment paste of the invention, is preferably below 10%, more preferably below 5%, and with particular preference below 1% by weight, and in particular is below the detection limit of the organic solvents.

The pigment paste of the invention comprises at least one mica pigment (A) and preferably at least two, more preferably at least three and in particular two, mica pigments (A). The mica pigments (A) are customary and known effect pigments having a layered construction comprising one layer of mica and at least one metal oxide layer (cf. Römpp Lexikon Lacke und Druckfarben, Georg Thieme Verlag, Stuttgart, N.Y., 1998, “Effect pigments”, page 176). The mica pigments (A) impart an optical effect and are included among what are known as pearlescent pigments; in addition, they may also impart color (cf. Römpp Lexikon Lacke und Druckfarben, Georg Thieme Verlag, Stuttgart, N.Y., 1998, “Pearlescent pigments”, “Mother of pearl pigments”, page 438). They are customary and known commercial products and are sold, for example, by Engelhard under the brand name Mearlin® or by Merck under the brand name Iriodin®.

In the pigment paste of the invention, based on its overall amount, the mica pigments (A) are present in an amount of from 15 to 25% by weight and in particular from 18 to 23% by weight.

The pigment paste of the invention may further comprise at least one pigment other than the mica pigments (A), selected preferably from the group consisting of organic and inorganic pigments, color pigments, optical effect pigments, electrically conductive pigments, magnetic pigments, magnetically shielding pigments, fluorescent pigments, phosphorescent pigments, anticorrosion pigments, and extender pigments, pigments having at least two of these properties, and nanoparticles, provided such an additional pigment does not adversely affect the performance properties of the pigment paste of the invention. With preference, the pigment paste of the invention contains no further pigment.

Based on its overall amount, the pigment paste of the invention contains from 0.45 to 0.75% by weight, in particular from 5 to 7% by weight, of at least one, especially one, nonassociative thickener comprising at least one methacrylate copolymer based on C₁-C₆ alkyl (meth)acrylate and (meth)acrylic acid, especially methacrylic acid. The thickener (B) preferably contains in copolymerized form at least two different C₁-C₆ alkyl (meth)acrylate monomers. Based on its overall amount it contains more preferably from 40 to 60% by weight of methacrylic acid in copolymerized form. The thickener (B) is used preferably in the form of an aqueous dispersion. With particular preference, use is made of the dispersions of thickeners (B) such as are described, for example, in German patent applications DE 196 52 842 A 1, column 3 line 42 to column 4 line 4, or DE 197 41 554 A 1, column 2 line 54 to column 3 line 15. Very particular preference is given to using an aqueous dispersion of the thickener (B) which is sold under the brand name Viscalex® HV 30 by Allied and has a thickener (B) content of 30% by weight.

Based on its overall amount, the pigment paste of the invention contains from 0.1 to 0.4% by weight, in particular from 0.2 to 0.3% by weight, of at least one, especially one, organic amine (C). The amine (C) is preferably selected from the group of the tertiary amines, preferably of the tertiary alkylamines, and especially of the tertiary hydroxyalkylamines. Examples of suitable tertiary hydroxyalkylamines are triethanolamine, methyldiethanolamine, and dimethylethanolamine, especially dimethylethanolaamine.

Based on its overall amount, the pigment paste of the invention further contains from 0.1 to 12% by weight, in particular from 0.5 to 10% by weight, of at least one nonionic surfactant. Suitable nonionic surfactants (cf. Römpp Lexikon Lacke und Druckfarben, Georg Thieme Verlag, 1998, page 410, “Nonionic surfactants”) in accordance with the invention are surfactants whose hydrophyllicity is brought about by polyether chains, hydroxyl groups, carboxamido groups, urethane groups and/or ester groups. Nonionic surfactants are commercial products and are sold, for example, under the brand name Tegodispers® 740 by Tego, under the brand name Hydropalat® 3037 by Cognis, or under the brand name Setalux® 6802 AQ 4 by Akzo. Preference is given to using Tegodispers® 740 and Hydropalat® 3037. Hydropalat® 3037 is a silicone-free surface-active leveling additive for aqueous systems, with a hydroxyl number of from 73 to 83 mg KOH/g and a hydrolysis number (DGF C-V 3) of from 56 to 62. Tegodispers® 740 is a nonionic modified fatty acid derivative free from aromatics, amine, and nonylphenol ethoxylate.

Based on its overall amount, the pigment paste of the invention contains not least at least 50% by weight and in particular at least 55% by weight of water.

The pigment paste of the invention may further comprise customary and known additives, such as customary coatings additives. It is, however, a particular advantage of the pigment paste of the invention that it need not contain any further additives in order to achieve the advantages according to the invention.

The preparation of the pigment pastes of the invention requires no peculiarities in terms of method but instead takes place in accordance with the customary and known methods of preparing pigment pastes or pigment formulations by mixing of the above-described ingredients in appropriate mixing equipment such as stirred tanks, dissolvers, Ultraturrax, inline dissolvers, stirred mills, bead mills or extruders. The skilled worker is aided on the basis of his or her general art knowledge to select the techniques and equipment in such a way that the particular mica pigments (A) to be dispersed are not damaged.

In accordance with the invention, the pigment paste of the invention is used for preparing aqueous effect, or color and effect, coating materials, especially aqueous basecoat materials.

For this purpose, the pigment paste of the invention is mixed with at least one aqueous mixing varnish and then the resulting mixture is homogenized. This is preferably carried out using the techniques and equipment described above.

The mixing varnish comprises at least one water-soluble and/or -dispersible binder. The binder is preferably selected from the group consisting of random, alternating, and block, linear, branched, and comb addition (co)polymers of ethylenically unsaturated monomers or polyaddition resins and/or polycondensation resins. Regarding these terms, refer to Römpp Lexikon Lacke und Druckfarben, Georg Thieme Verlag, Stuttgart, N.Y., 1998, page 457, “Polyaddition” and “Polyaddition resins (polyadducts)”, and also pages 463 and 464, “Polycondensates”, “Polycondensation” and “Polycondensation resins”, and also pages 73 and 74, “Binders”.

The addition (co)polymers of ethylenically unsaturated monomers are preferably selected from the group consisting of (meth)acrylate (co)polymers and partially hydrolyzed polyvinyl esters, especially (meth)acrylate copolymers, and the polyaddition resins and/or polycondensation resins are preferably selected from the group consisting of polyesters, alkyds, polyurethanes, polylactones, polycarbonates, polyethers, epoxy resin-amine adducts, polyureas, polyamides, polyimides, polyester-polyurethanes, polyether-polyurethanes, and polyester-polyether-polyurethanes, especially polyester-polyurethanes.

Very particular preference is given to using the binders such as are employed in customary and known aqueous basecoat materials. Binders of this kind are described, for example, in German patent application DE 196 52 842 A 1, column 2 line 53 to column 3 line 46, and in German patent application DE 199 14 896 A 1, column 5 line 34 to column 11 line 5.

The binders are used in the mixing varnish in the amounts which are customary and known for aqueous basecoat materials.

The mixing varnish may further comprise customary and known crosslinking agents, and additives in the customary and known amounts such as are described, for example, in German patent application DE 199 14 896 A 1, column 11 line 6 to column 16 line 16.

It is essential that in the process of the invention the pigment paste of the invention is used in an amount such that the resulting aqueous effect, or color and effect, coating material contains based on its overall amount
from 2 to 6% by weight of at least one of the mica pigments (A),
from 0.1 to 2% by weight of at least one of the nonassociative thickeners (B) comprising at least one methacrylate copolymer based on C₁-C₆ alkyl (meth)acrylate and (meth)acrylic acid, and
from 0.02 to 2.4% by weight of at least one of the nonionic surfactants (D).

The resulting aqueous coating materials, especially the aqueous basecoat materials, may be curable physically, thermally with self-crosslinking and/or external crosslinking, with actinic radiation, or thermally and with actinic radiation. By actinic radiation is meant near infrared (NIR), visible light, UV radiation or X-rays, especially UV radiation, and also corpuscular radiation, such as electron beams. Conjoint thermal curing and curing with actinic radiation is also referred to by those in the art as dual cure.

The aqueous basecoat materials are preferably used for producing multicoat effect, or color and effect, paint systems on primed and unprimed substrates.

Suitable substrates include all surfaces to be coated which are not damaged by curing of the coating systems present thereon using heat or heat and actinic radiation. Suitable substrates consist, for example, of metals, plastics, wood, ceramic, stone, textile, fiber composites, leather, glass, glass fibers, glass wool, rock wool, mineral-bound and resin-bound building materials, such as plasterboard and cement slabs or roof shingles, and also combinations of these materials. The surfaces of these materials may have already been painted or coated.

Accordingly, the aqueous basecoat materials are especially suitable for painting motor vehicle bodies and parts thereof, the interior and exterior of motor vehicles, the interior and exterior of buildings, doors, windows, and furniture, and, in the context of industrial coating, for the painting of parts made of plastic, especially transparent plastics parts, small parts, coils, containers, packaging, electrical components, and white goods, and also for the coating of hollow glassware.

The aqueous basecoat materials are very suitable indeed for the original (OEM) finishing and refinish of motor vehicles, especially automobiles.

In the case of electrically conductive substrates, primers can be used, which are produced in a customary and known manner from electrocoat materials. Both anodic and cathodic electrocoat materials are suitable for this purpose, but especially cathodic electrocoats.

The coating of the invention may also be used to paint primed or unprimed plastics such as, for example, ABS, AMMA, ASA, CA, CAB, EP, UF, CF, MF, MPF, PF, PAN, PA, PE, HDPE, LDPE, LLDPE, UHMWPE, PET, PMMA, PP, PS, SB, PUR, PVC, RF, SAN, PBT, PPE, POM, PUR-RIM, SMC, BMC, PP-EPDM and UP (codes according to DIN7728T1) and polymer blends thereof, or the fiber reinforced composite materials produced using these plastics.

Nonfunctionalized and/or apolar substrate surfaces may be subjected prior to coating in a known manner to a pretreatment, such as with a plasma or by flaming, or provided with a hydro primer.

The multicoat paint systems may be produced in a variety of ways. Preference is given to the wet-on-wet techniques described in German patent application DE 199 30 664 A 1, page 15 lines 36 to 58, or in German patent application DE 199 14 896 A 1, column 2 line 15 to column 3 line 24 and column 16 line 54 to column 18 line 54.

This is done using the customary and known techniques and equipment for the application and curing of coating materials, especially aqueous coating materials.

Owing to the outstanding distribution of the mica pigments (A) in the pigment paste of the invention, and its storage stability, the end results are multicoat paint systems of outstanding shade stability and stability of the optical effects. The multicoat paint systems may therefore be used with advantage for the OEM finishing and refinish of top-class automobiles.

### INVENTIVE AND COMPARATIVE EXAMPLES

### Inventive Examples 1 and 2

The Preparation of Aqueous Pigment Pastes Comprising Mica Pigments but Free from Binders and Grinding Resins

The pigment pastes of examples 1 and 2 were prepared by mixing together the ingredients listed in the table and homogenizing the mixture.

TABLE
Physical composition of the aqueous pigment pastes of examples 1 and 2

| | Example 1 | Example 2 |
|---|---|---|
| Ingredient | (% by wt.) | (% by wt.) |
| Mica pigments (A): | | |
| Mica pigment 64517 | 21.1 | 18.2 |
| Mica pigment 64585 | 3.7 | 3.1 |
| Thickeners (B): | | |
| Viscalex ® HV 30 from Allied | 0.2 | 0.21 |
| (methacrylate copolymer, | | |
| 30% by weight in water) | | |
| Organic amine (C): | | |
| Dimethylethanolamine | 2.3 | 2.43 |
| (10% by weight in water) | | |
| Nonionic surfactant (D): | | |
| Hydropalat ® 3037 from Henkel | 1.16 | — |
| Tegodispers ® 740 from Tego | — | 1.21 |
| Water (E) | 51.74 | 54.06 |

The pigment pastes of examples 1 and 2 showed no settling and formation of a watery phase even after six months. They were outstandingly suitable for the preparation of particularly high-grade aqueous basecoat materials for producing multicoat effect paint systems for top-class automobiles.

### Comparative Example

The Preparation of a Pigment Paste Comprising Binder, Crosslinking Agent, Organic Solvents, and Mica Pigments

For the preparation of the pigment paste an aqueous mixing varnish was prepared from 15 parts by weight of a polyurethane resin dispersion, 6.06 parts by weight of a melamine resin, 1.15 parts by weight of a 3% by weight aqueous dispersion of a phyllosilicate, 0.01 part by weight of methanol, 0.6 part by weight of isobutanol, 11.62 parts by weight of 2-butoxyethanol, 0.09 part by weight of methyl ethyl ketone, 0.56 part by weight of dimethylethanolamine, 1.15 parts by weight of a polyalkylene glycol (Pluriol® P 900 from BASF Aktiengesellschaft), 63.75 parts by weight of deionized water, and 0.06 part by weight of formaldehyde.

The pigment paste was prepared from 75 parts by weight of the mixing varnish, 21.3 parts by weight of the mica pigment 64517 and 3.7 parts by weight of the mica pigment 64585. The pigment paste underwent coagulation after just one week, forming a watery phase. Thereafter it was no longer suitable for the preparation of aqueous basecoat materials.

1. An aqueous pigment paste free from binders and grinding resins, comprising based on its overall amount
(A) from 15 to 25% by weight of at least one mica pigment,
(B) from 0.45 to 0.75% by weight of at least one nonassociative thickener comprising at least one methacrylate copolymer based on C₁-C₆ alkyl (meth)-acrylate and (meth)acrylic acid,
(C) from 0.1 to 0.4% by weight of at least one organic amine,
(D) from 0.1 to 12% by weight of at least one nonionic surfactant, and
(E) at least 50% by weight of water.

2. The paste of claim 1, wherein the at least one mica pigment (A) is present in an amount from 18 to 23% by weight.

3. The paste of claim 1, wherein the at least one nonassociative thickener (B) is present in an amount from 0.5 to 0.7% by weight.

4. The paste of claim 1, wherein the thickener (B) contains in copolymerized form at least two different C₁-C₆ alkyl (meth)acrylate monomers.

5. The paste of claim 1, wherein the thickener (B), based on its overall amount, contains from 40 to 60% by weight of methacrylic acid in copolymerized form.

6. The paste of claim 1, wherein the organic amine (C) comprises a tertiary amine.

7. The paste of claim 6, wherein the tertiary amine comprises a hydroxylalkylamine.

8. The paste of claim 7, wherein the hydroxyalkylamine is dimethylethanolamine.

9. The paste of claim 1, wherein the organic amine (C) is present in an amount of from 0.2 to 0.3% by weight.

10. The paste of claim 1, wherein the nonionic surfactant (D) is present in an amount of from 0.5 to 10% by weight.

11. The paste of claim 1 wherein the water is present in an amount that is at least 55% by weight.

12. An aqueous coating material comprising the aqueous pigment paste of claim 1, wherein the aqueous coating material is one of an aqueous effect coating material or a color and effect, coating material.

13. The coating material of claim 12, wherein the aqueous coating material is an aqueous basecoat material.

14. The coating material of claim 12, wherein the aqueous coating material can produce a multicoat effect, or color and effect, paint system.

15. A process for preparing an aqueous effect or color and effect coating material by mixing the at least one pigment paste of claim 1 with at least one aqueous mixing varnish comprising at least one water-soluble and/or -dispersible binder in an amount such that the resulting aqueous effect or color and effect coating material comprises based on its overall amount
from 2 to 6% by weight of at least one mica pigment (A),
from 0.1 to 2% by weight of at least one nonassociative thickener (B) comprising at least one methacrylate copolymer based on C₁-C₆ alkyl (meth)-acrylate and (meth)acrylic acid, and
from 0.02 to 2.4% by weight of at least one nonionic surfactant (D), and homogenizing the resulting mixture.

16. The process of claim 15, wherein the binder is at least one of an addition (co)polymers of at least one ethylenically unsaturated monomer, a polyaddition resin, and/or a polycondensation resin, wherein the addition (co)polymer is at least one of a random (co)polymer, an alternating (co)polymer, and a block (co)polymer, and wherein the addition (co)polymer is at least one of linear, branched, and comb.

17. The process of claim 16, wherein the addition (co)polymer of at least one ethylenically unsaturated monomer is at least one of a (meth)acrylate (co)polymer and/or a partially hydrolyzed polyvinyl ester, and the polyaddition resin and/or polycondensation resin is at least one of a polyester, an alkyd, a polyurethane, a polylactones, a polycarbonate, a polyether, an epoxy resin-amine adduct, a polyurea, a polyamide, a polyimide, a polyester-polyurethane, a polyether-polyurethane, and/or polyester-polyether-polyurethane.
